(19) United States
(12) Patent Application Publication
(10) Pub. No.: US 2016/0225251 A1
(43) Pub. Date: Aug. 4, 2016

(54) DEVICE FOR CONFIGURING A FIRE-DETECTION SYSTEM

(71) Applicant: FINSECUR, Nanterre (FR)

(72) Inventors: Stéphane DI MARCO, NANTERRE (FR); Sylvain ROCHET, NANTERRE (FR)

(21) Appl. No.: 14/654,682

(22) PCT Filed: Dec. 23, 2013
(86) PCT No.: PCT/FR2013/053255

§ 371 Date: Jun. 22, 2015

(30) Foreign Application Priority Data
Dec. 21, 2012 (FR) 1262690

(51) Int. Cl. G08B 29/20; G08B 29/14

(52) U.S. Cl. CPC G08B 29/20; G08B 29/145

(57) ABSTRACT

A device to configure a fire-detection system includes at least one smoke detector. Each smoke detector includes a sensor to measure the value of a physical magnitude near the sensor and to transmit a signal representative of the value, and a smoke detector to detect the presence of a fire based on the processing of the signal transmitted by the sensor. The device further includes at least one transceiver for short-range wireless communication of a signal representative of the presence of a fire, and a portable communicating terminal. The terminal includes a receiver to receive the signal communicated by the transmitter, and a screen to display a message representative of the signal received from the transmitter. A configurator of the terminal configures at least one parameter value of the processing performed by the smoke detector, and the signal representative of the parameter value is wirelessly transmitted to the transceiver.

### TECHNICAL FIELD OF THE INVENTION

The present invention relates to a device for configuring a fire-detection system. It applies in particular to making private and public spaces safe.

### STATE OF THE ART

Making private or public spaces safe against the risk of fire is based upon the effective detection of the risk. In order to detect a fire risk, a set of smoke sensors for example is installed over a site. These sensors measure the amount of smoke in the ambient air, compare it to a limit value and emit a sound signal if this is exceeded, for example. In order to certify an installed system as safe, a check of the system's effectiveness must be carried out with the fire service. To carry out this check, one places some standard fires close to the sensors and one observes whether the sensors detect these fires. However, in cases of non-detection, the diagnosis is imprecise since it is limited to the fact that the detector did not detect the standard fire.

In addition to the installation, the costs and effectiveness of the maintenance are also dependent upon such a diagnosis.

The current systems have the drawback of too limited a diagnosis of the causes of a sensor's malfunction.

### SUBJECT OF THE INVENTION

The present invention aims to remedy all or part of these drawbacks.

To this end, the present invention envisages, according to a first aspect, a device for configuring a fire-detection system that comprises at least one detector, each detector comprising a sensor for measuring the value of a physical magnitude near the sensor to transmit a signal that is representative of said value, and a means for detecting the presence of a fire based on the processing of the signal transmitted by said sensor, that also comprises:
at least one means for short-range wireless communication of a signal that is representative of the presence of a fire, and
a portable communicating terminal comprising:
   a means for receiving the signal communicated by said communication means,
   a screen for displaying a message representative of the signal received from the communication means,
   a means for configuring at least one parameter value for the processing performed by at least one means for detecting the presence of a fire, and
   a means for wirelessly transmitting a signal representative of each parameter value configured by the configuration means,
      the communication means being configured to receive the signal representative of each parameter value configured by the configuration means.

Thanks to these provisions, a user equipped with a portable communicating terminal can estimate the measured value of the physical magnitude captured by the sensor. In this way, it is possible for a user to compare the captured physical magnitude against an expected value. In addition, this device makes it possible to establish whether the sensor is working, or if the source of a malfunction is in another part of the device.

A user equipped with a portable communicating terminal can parameterize the processing carried out by the detection means according to its location in a room. In this way, the device enables a precise diagnostic to be transformed into a simplified adjustment of each detector's operation.

In addition, a user equipped with a portable communicating terminal is able to monitor the detector's ability to issue a fire alarm signal. Thus, the user is able to determine more precisely the source of a malfunction.

In some embodiments, the communication means is configured to receive said predefined limit value from the portable communicating terminal.

These embodiments allow the sensitivity of at least one detector to be modified to ensure that it is able to make a room safe, regardless of where a fire is located in the room.

In some embodiments, the communication means is configured to transmit to the portable communicating terminal the measurement of the value of a physical magnitude supplied by the sensor, and the display screen is configured to display a message representative of the measurement received by the portable communicating terminal.

Thanks to these provisions, a user equipped with a portable communicating terminal can view the measured value of the physical magnitude captured by the sensor. In this way, it is possible for a user to compare the captured physical magnitude against an expected value. In addition, this device makes it possible to establish whether the sensor is working, or if the source of a malfunction is in another part of the device.

In some embodiments, the communication means is configured to transmit a signal confirming reception of at least one message received by said detector.

These embodiments have the advantage of allowing at least one detector to be identified by a user equipped with a portable communicating terminal. In this way, the user can have better knowledge of the layout of the detectors.

In some embodiments, the portable communicating terminal comprises a memory of the location of at least one detector, and a means of storing, in the portable communicating terminal's location memory, an identifier transmitted by a detector's communication means.

In some embodiments, at least one detector comprises a location memory, and a means of storing, in the location memory, an item of location information transmitted by the portable communicating terminal and received by the communication means, the communication means being configured to transmit an item of information representative of the item of location information with a signal representative of the presence of a fire.

Each of these embodiments has the advantage of allowing a user to carry out an addressing of the sensors so as to make it easier to locate a fire, either by associating a detector identifier to a location, or by the detector transmitting an item of location information with the fire detection signal.

In some embodiments, at least one detector comprises an amplifier of the signal transmitted by the communication means, the communication means being configured to receive a gain set point for said transmitted signal amplifier from the portable communicating terminal.

In some embodiments, at least one detector comprises an amplifier of the signal received by the communication means, the communication means being configured to receive a gain set point for said received signal amplifier from the portable communicating terminal.

In some embodiments, at least one detector comprises an amplifier of the alarm signal by the communication means, the communication means being configured to receive a gain set point for said alarm signal amplifier from the portable communicating terminal (30).

Thanks to each of these provisions, the user can select a transmission or consumption power level, in order to achieve a compromise between the detector's performance and the autonomy of its electrical power supply.

In some embodiments, the wireless transmission means of the portable communicating terminal is configured to transmit to an alarm control unit each parameter value configured by the configuration means for each detector.

Thanks to these provisions, the alarm control unit has access to all the configurations of the detectors. The portable communicating terminal can therefore be used just for the initial configuration and/or for maintenance or test operations.

In some embodiments, at least one detector of the device that is the subject of the present invention comprises:
at least one internal power supply, and
at least one means for estimating the level of power available in the internal power supply,
   wherein the communication means is configured to transmit a signal representative of the available power level estimated by the estimation means.

These embodiments have the advantage of allowing a user equipped with a portable communicating terminal to view the level of available power in a detector. In this way, these embodiments improve a user's ability to perform a diagnosis of the device.

In some embodiments, the device that is the subject of the present invention comprises a means of transmitting an alarm signal to at least one recipient of signals, if the presence of a fire is detected, the portable communicating terminal being configured to control the operation of the means of transmitting an alarm signal.

These embodiments make it possible, firstly, for the device to contact the emergency services if a fire is detected, and secondly for a user equipped with a portable communicating terminal to deactivate this contact, in the event of system maintenance, for example.

In some embodiments, the communication means of at least one detector uses a WiFi protocol and/or Bluetooth technology.

These embodiments have the advantage of using reliable, recognized short-range communication technologies.

The present invention envisages, according to a second aspect, a portable communicating terminal for configuring a detector comprising a sensor for measuring the value of a physical magnitude near the sensor to transmit a signal that is representative of said value, a means for detecting the presence of a fire based on the processing of the signal transmitted by said sensor, and a means for short-range wireless communication of a signal that is representative of the presence of a fire, that comprises:
a means for receiving the signal communicated by said communication means,
a screen for displaying a message representative of the signal received from the communication means,
a means for configuring at least one parameter value for the processing performed by at least one means for detecting the presence of a fire, and
a means for wirelessly transmitting to the detector a signal representative of each parameter value configured by the configuration means.

The present invention envisages, according to a third aspect, a detector of a fire-detection system, comprising a sensor for measuring the value of a physical magnitude near the sensor to transmit a signal that is representative of said value, and a means for detecting the presence of a fire based on the processing of the signal transmitted by said sensor, characterized in that:
it also comprises a short-range wireless communication means for communicating a signal representative of the presence of a fire and for receiving a signal representative of each parameter value configured by a configuration means of a portable communicating terminal, and
the detection means utilizes at least one parameter value received by the communication means for detecting the presence of a fire.

The present invention envisages, according to a fourth aspect, a method for configuring a fire detection system that comprises at least one detector, each detector performs:
a step of capturing a measurement of a physical magnitude near a sensor to transmit a signal that is representative of said value;
a step of detecting the presence of a fire based on the processing of the signal transmitted by said sensor;
a step of short-range wireless communication of a signal that is representative of the presence of a fire; and
   a portable communicating terminal performs:
a step of receiving the signal communicated by said communication means;
a step of displaying a message representative of the signal received from the communication means;
a step of configuring at least one parameter value for the processing performed by at least one means for detecting the presence of a fire; and
a step of wirelessly transmitting a signal representative of each parameter value configured by the configuration means; and
   the detector also performing a step of receiving, by the communication means, the signal representative of each parameter value configured by the configuration means.

The present invention envisages, according to a fifth aspect, a device for configuring a fire-detection system that comprises at least one detector equipped with a sensor for measuring the value of a physical magnitude near the sensor to transmit a signal that is representative of said value, that also comprises:
at least one means for short-range wireless communication of a signal representative of said value,
a portable communicating terminal configured to receive the signal communicated by said communication means and to display on a screen a message representative of the value of the physical magnitude,
a means of transmitting an alarm signal to at least one recipient of signals, if the presence of a fire is detected,
   the portable communicating terminal being configured to control the operation of the means of transmitting an alarm signal.

As the advantages, aims and special features of this terminal, this detector, this method and this device, that are the subjects of the second to fifth aspects of the present invention are similar to those of the device that is the subject of first aspect of the present invention, they are not repeated here.

The principal or particular features of the various aspects of the present invention are particular features of particular embodiments of other aspects of the present invention.

### BRIEF DESCRIPTION OF THE FIGURES

Other advantages, aims and features of the invention will become apparent from the description that follows of at least one particular embodiment of the fire-detection device, made, as a non-limiting example, with reference to drawings included in an appendix, wherein:

FIG. 1 represents, schematically, a first particular embodiment of the device for configuring a fire-detection device that is the subject of the present invention;

FIG. 2 represents, schematically, a second particular embodiment of the device for configuring a fire-detection device that is the subject of the present invention;

FIG. 3 represents, schematically, a particular embodiment of the portable communicating terminal that is the subject of the present invention; and

FIG. 4 represents, in the form of a logical diagram, steps in a particular embodiment of the method for configuring a fire-detection system that is the subject of the present invention.

### DESCRIPTION OF EXAMPLES OF REALIZATION OF THE INVENTION

It is now noted that the figures are not to scale.

It is recalled here that the configuration of a software system, a piece of equipment or a computer network is a set of technical characteristics that are not dependent on the manufacturer; instead, they are the result of choices made by the purchaser and user. These characteristics are therefore likely to vary greatly, even for objects of identical construction.

In the context of the present invention, the configuration concerns the software configuration, which mainly derives from the way in which the system of files is organized by the user, from the software systems installed and their versions. The software configuration also includes setting the value of the configuration parameters that allow their behavior to be adjusted to the hardware, software and network configuration of the computer system in which the software is installed.

Preferably, in embodiments of the device that is the subject of the present invention, the configuration comprises:
at least one limit value for a value of a signal representative of a physical magnitude (e.g. heat, gas, smoke or other particles in suspension) above which a fire, or at least a danger, is considered detected;
at least one amplification power level for an alert signal, visual or sound signal, remotely transmitted signal, wireless and/or signal received from another system; and/or
a location of the detector, i.e. the place where it is located, in the site that is the subject of the monitoring or the information representing this detector's neighboring detectors.

The configuration parameters are typically stored in text files that the user can modify by means of a standard text editor.

The term “short-range wireless communication” means a communication between two appliances in which the messages are carried by waves with a frequency that is higher than 3 MHz. Such frequencies are therefore higher than or belong to the category of high frequencies. The maximum range of these communications is generally less than one hundred meters.

Throughout the description, the terms “user” and “operator” are used interchangeably to refer to the person who operates the portable communicating terminal, whatever his function.

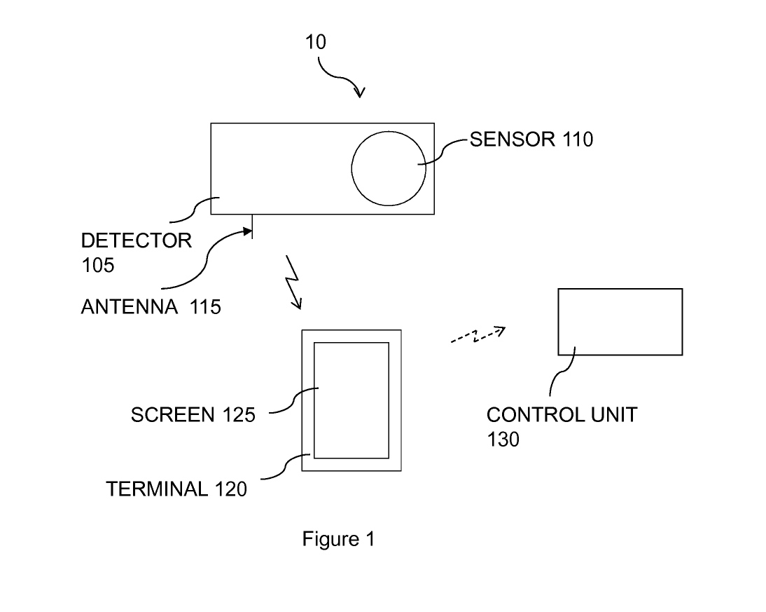

FIG. 1 shows the first particular embodiment of the device 10 that is the subject of the present invention. This device 10 comprises:
at least one detector 105 equipped with a sensor 110 for measuring the value of a physical magnitude near the sensor;
at least one means 115 for communicating a signal representative of said value; and
at least one portable communicating terminal 120 equipped with a screen 125.

Each detector 105 can be, for example, a housing that can be fixed onto a surface of a room, e.g. the ceiling or a wall. This housing allows the air to flow to a sensor 110 located in the housing.

This sensor 110 for measuring the value of a physical magnitude near the sensor 110 to transmit a signal that is representative of said value, can be, for example, an optical smoke sensor. In variants, this sensor 110 can be an ionization sensor, which detects the presence of smoke by the variation in a current caused by the presence of smoke in the air.

Each means 115 for short-range wireless communication of a signal representative of said value can be, for example, an antenna for short-range transmission.

Each portable communicating terminal 120 is configured to receive the signal communicated by said communication means 115 and to display on a screen 125 a message representative of the value of the physical magnitude. Each portable communicating terminal 120 can be, for example, a tablet, portable computer or smartphone. Each portable communicating terminal 120 can, in addition, comprise an antenna configured to receive short-range communications. The displayed message representative of the value of the physical magnitude can be, for example, the quantity or density of smoke detected in the ambient air by a sensor 110.

In some embodiments, the portable communicating terminal 120 also communicates, wirelessly and at short range, with an alarm control unit 130, when the distance between the terminal 120 and the control unit 130 is sufficiently short. As described below, this communication allows the control unit 130 to know the parameter values used by the detectors 105.

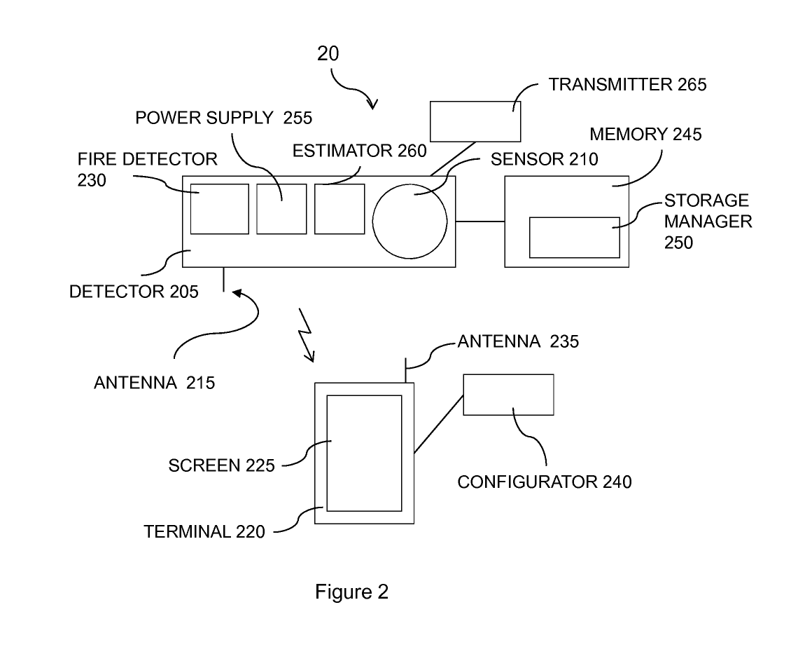

FIG. 2 shows a second particular embodiment of the device 20 that is the subject of the present invention. This device 20 comprises:
at least one detector 205, that comprises:
   a sensor 210 for measuring the value of a physical magnitude near the sensor;
   a means 230 for detecting the presence of a fire;
   at least one internal power supply 255; and
   at least one means 260 for estimating the level of power available in the internal power supply,
a memory 245 equipped with a storage means 250;
a means 265 of transmitting an alarm message;
at least one means 215 for communicating a signal representative of said value; and
at least one portable communicating terminal 220, that comprises
   a screen 225;
   a means 240 for configuring at least one parameter value for the processing performed by at least one detection means 230, and
   a means 235 for wirelessly transmitting a signal representative of each parameter value configured.

Each detector 205 can be, for example, a housing that can be fixed onto a surface of a room, e.g. the ceiling or a wall. This housing allows the air to flow to a sensor 210 located in the housing.

In addition, each detector comprises a sensor 210 for measuring the value of a physical magnitude near the sensor 210 to transmit a signal that is representative of said value, which can be, for example, an optical smoke sensor. In variants, this sensor 210 can be an ionization sensor, which detects the presence of smoke by the variation in a current caused by the presence of smoke in the air.

Each detector 205 also comprises a means 230 for detecting the presence of a fire based on the processing of the signal transmitted by said sensor 210 of said detector 205. This detection means 230 compares the measurement of the physical magnitude against a predefined limit value and, if this is exceeded, detects the presence of a fire near the sensor 210.

Each detector 205 also comprises at least one internal power supply 255. Such a power supply 255 can be, for example, a cell or a battery.

Lastly, each detector 205 comprises at least one means 260 for estimating the level of power available in the internal power supply 255. This estimation means 260 can, for example, measure the internal resistance of the internal power supply 255 to calculate the power still available in this internal power supply 255.

This device 20 also comprises a memory 245 of the location of at least one sensor 210. This memory 245 can be, for example, a control unit, comprising a random-access and/or read-only memory and a central processing unit, connected to at least one detector 205.

This memory 245 comprises a means 250 of storing, in the location memory 245, a location transmitted by a portable communicating terminal 220. This storage means 250 can be, for example, a computer program able to access the resources of the memory 245 and modify its contents.

This device 20 also comprises a means 265 of transmitting an alarm signal to at least one recipient of signals, if the presence of a fire is detected. This transmission means 265 can be a transmitter over a telephone or internet network, for example.

This device 20 also comprises a means 215 for short-range wireless communication of a signal representative of said value. This communication means 215 can be, for example, an antenna an antenna for short-range transmission. This communication means 215 is configured for:
receiving the signal representative of each parameter value configured by the configuration means 240;
transmitting a signal representative of the presence of a fire detected by a detection means 230;
receiving a predefined limit value from the portable communicating terminal 220 corresponding to the limit value for detecting the presence of a fire by the detection means 230;
transmitting a signal confirming reception of at least one message received by a detector 205; and
transmitting a signal representative of the available level of power of an internal power supply 255 estimated by the estimation means 260.

This communication means 215 uses a WiFi protocol and/or Bluetooth technology.

Lastly, this device 20 comprises a portable communicating terminal 220 such as, for example, a portable computer, a tablet or a smartphone. This terminal 220 comprises a screen 225.

This terminal 220 also comprises a means 240 for configuring at least one parameter value for the processing performed by at least one means 230 for detecting the presence of a fire. This configuration means 240 can be, for example, a computer program with a graphical user interface that allows the user to vary a fire's detection limit value of the detection means 230.

This terminal 220 also comprises a means 235 for wirelessly transmitting a signal representative of each parameter value configured by the configuration means 240. This transmission means 235 can be, for example, a WiFi or Bluetooth (registered trademarks) antenna.

The memory 245 stores a location of the detector. The storage means 250 stores, in the location memory 245, an item of location information transmitted by the portable communicating terminal and received by the communication means 215. The communication means 215 is configured to transmit an item of information representative of the item of location information with a signal representative of the presence of a fire. This item of information representative of the item of location information is selected by a user with a user interface of the portable communicating terminal 30, or it is determined by an automatic location, e.g. a geolocation means based on signals transmitted by satellites or by ground transmitters.

This item of location information, transmitted with an alarm signal, allows an alarm control unit to match a detector identifier, received with a fire detection signal, and a location of the detector in alarm condition, on the protected site. Emergency teams can thus be quickly informed by the control unit of the location of the fire detection.

The portable communicating terminal 220 is configured for:
transmitting a signal to at least one detector 205; and
controlling the operation of the means 265 of transmitting an alarm message.

In variants, the detector 205 comprises an amplifier of the signal transmitted by the communication means 215, the communication means being configured to receive a configuration parameter value representative of a gain set point for said transmitted signal amplifier from the portable communicating terminal 30.

In variants, the detector 205 comprises an amplifier of the signal received by the communication means 215, the communication means being configured to receive a configuration parameter value representative of a gain set point for said received signal amplifier from the portable communicating terminal 30.

In variants, the detector 205 comprises an amplifier of the alarm signal by the communication means 215, the communication means being configured to receive a configuration parameter value representative of a gain set point for said alarm signal amplifier from the portable communicating terminal 30.

In this way, different amplifier gains can be adjusted by the portable communicating terminal to achieve a compromise between the fire detector system's performance and the autonomy of the detectors' electrical power supply. The values of the gains can be chosen by a user of the portable communicating terminal or by a software system taking into account a power level of the received signal measured by the portable communicating terminal or the detector, a distance to an alarm control unit or a location of the detector, for example.

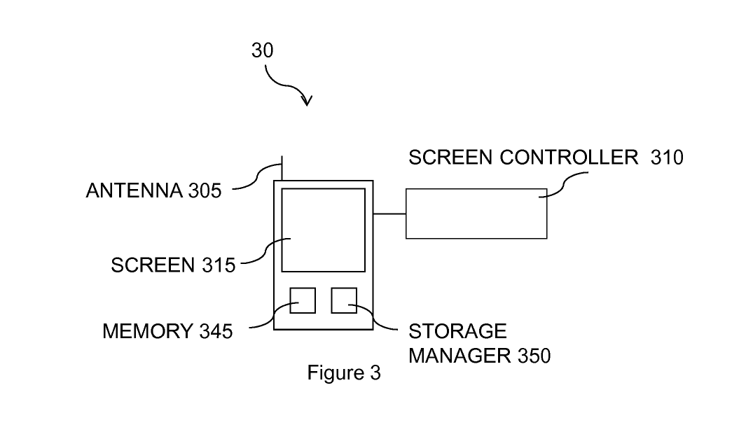

FIG. 3 shows a particular embodiment of the portable communicating terminal 30 that is the subject of the present invention. This terminal 30 comprises:
a means 305 for short-range wireless reception of a signal representative of a measured value of a physical magnitude representative of a fire; and
a means 310 for displaying, on a screen 315, a message representative of the value of the physical magnitude.

This wireless reception means 305 can be, for example, a WiFi or Bluetooth antenna. The display means 310 can be, for example, a screen controller.

In some embodiments, the portable communicating terminal 30 comprises a memory 345 of the location of at least one detector, and a means 350 of storing, in the portable communicating terminal's location memory, an identifier transmitted by a detector's communication means. The portable communicating terminal 30 thus allows an alarm control unit, after transmission of this identifier and a location selected by means of a user interface or by geolocation, to match a detector identifier, received with a fire detection signal, to a location of the detector in alarm condition, on the site protected. Emergency teams can thus be quickly informed by the control unit of the location of the fire detection.

In some embodiments, the wireless transmission means of the portable communicating terminal 30 is configured to transmit to an alarm control unit each parameter value configured by the configuration means for each detector 205. In this way, the alarm control unit can take these parameter values into account.

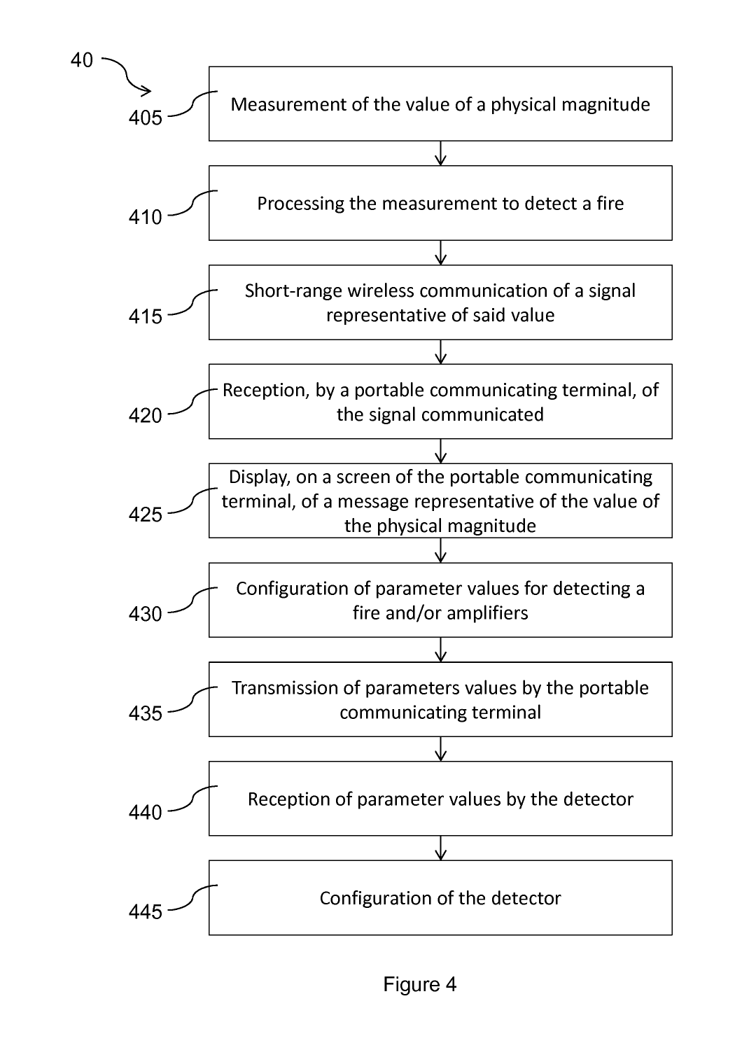

FIG. 4 shows a particular embodiment of the method 40 for configuring a fire-detection system that is the subject of the present invention.

In some embodiments, each detector 20, when it is connected to the portable communicating terminal 30, performs:
a step 405 of capturing a measurement of a physical magnitude near a sensor to transmit a signal that is representative of said value;
a step 410 of detecting the presence of a fire based on the processing of the signal transmitted by said sensor; and
a step 415 of short-range wireless communication of a signal that is representative of the presence of a fire.

The portable communicating terminal 30 performs:
a step 420 of receiving the signal communicated by said communication means;
a step 425 of displaying a message representative of the signal received from the communication means;
a step 430 of configuring at least one parameter value for the processing performed by at least one means for detecting the presence of a fire, and possibly amplifier gains for the detectors; and
a step 435 of wirelessly transmitting a signal representative of each parameter value configured by the configuration means.

The detector 20 performs:
a step 440 of receiving, by the communication means, the signal representative of each parameter value configured by the configuration means; and
a step 445 of parameterizing the processing carried out by the means for detecting the presence of a fire and, if the configured parameters comprise amplifier gains, the parameterization of the communication means.

The step 405 for measuring the value of a physical magnitude near a sensor can be carried out by utilizing an optical sensor of a quantity of smoke in the ambient air near a sensor, for example.

The processing step 410 matches the measurement and fire detection values, for example a limit value above which the measurement corresponds to a detected fire.

The communication step 415 can be performed, for example, by transmitting an electromagnetic wave comprising a signal representative of the value of a physical magnitude near a sensor, by a Bluetooth antenna.

The reception step 420 can be performed, for example, by utilizing a Bluetooth antenna of the portable communicating terminal.

The display step 425 can be performed, for example, by utilizing a graphical user interface of a computer program of the portable communicating terminal.

The step 430 for configuring at least one parameter value of the processing performed by at least one means for detecting the presence of a fire and gain values is performed by utilizing a user interface on a screen of the portable communicating terminal, the user selecting parameter values, and/or by utilizing a software system for automatically adjusting parameter values.

The step 445 of parameterizing the processing performed by the means for detecting the presence of a fire and, if the configured parameters comprise amplifier gains, the parameterization of the communication means, is carried out by storing the parameter values received in a memory used during the operation of the detector.

In this way, as can be seen by reading the description above, the present invention makes it possible to identify, near a sensor, if it detects a fire situation, in particular during installation tests consisting of lighting at least one standardized fire near this sensor. When several sensors are present, it is thus possible to detect which one is triggered first and, possibly, to detect aeraulic effects and possibly to improve the positioning of the sensors.

In this way, the present invention makes it possible to perform a precise diagnosis of the causes of the malfunction of a device for detecting a fire.

This diagnosis is greatly improved and simplified in the embodiment shown in FIG. 2 since it makes it possible to remotely evaluate and modify the operation of a detection means and evaluate the level of power available in each detector. In addition, these embodiments have better overall performance, since it is possible for a user to deactivate the message to the emergency service during maintenance of the system. In addition, the addressing of the sensors enables a simplified intervention by the staff concerned if a fire is detected.

A diagnosis improved in this way allows an operator to configure a fire detection system during installation, maintenance, or during testing, in the following ways:

In the case of a sensor detecting a value of a physical magnitude near the sensor that is too low, it is possible for the operator to move the detector until a satisfactory value is obtained for the device to make the operating area safe.

It is also possible to set the detection limit value of the detection means so as to adjust the sensitivity of the device. This aspect, in particular, can prove useful when there are a limited number of sensors.

In the case where a power level of a power supply is low, it is possible for an operator to change it, and thus be sure of the device's future operation.

The system can be configured such that an operator can, before beginning maintenance, installation or test operations, change the recipient of alarm messages so as to not inadvertently alert the emergency services during these operations.

The system can be configured to change the stored locations of sensors in an alarm control unit. This makes it possible, in addition, to support a sensor being physically moved from one location to another by changing the address in an alarm control unit's memory. In addition, this configuration change requires no manual intervention by an operator at the location of the alarm control unit.

Lastly, such a configuration allows an operator to quickly identify a detector on the device.

1-16. (canceled)

17. Device for configuring a fire-detection system, comprising:
at least one smoke detector, each smoke detector comprises a sensor to measure a measurement value of a physical magnitude near the sensor to transmit a signal representative of the measurement value;
at least one fire detector to detect a presence of a fire based on processing of the signal transmitted by the sensor;
at least one short-range transceiver to wirelessly transmit a signal representative of the presence of a fire;
a portable communicating terminal comprising:
a receiver for receiving the signal communicated by said at least one transceiver;
a display screen to display a message representative of the signal received from said at least one transceiver;
a configurator to configure at least one parameter value of processing performed by said at least one fire detector;
a transmitter to wirelessly transmit a signal representative of each parameter value configured by the configurator; and
said at least one transceiver is configured to receive the signal representative of each parameter value configured by the configurator.

18. Device according to claim 17, wherein said at least one fire detector is configured to compare the signal transmitted by the sensor against a predefined limit value; and wherein said at least one transceiver is configured to receive the predefined limit value from the portable communicating terminal.

19. Device according to claim 17, wherein said at least one transceiver is configured to transmit to the portable communicating terminal the measurement value of the physical magnitude supplied by the sensor; and wherein the display screen is configured to display a message representative of the measurement value received by the portable communicating terminal.

20. Device according to claim 17, wherein said at least one transceiver is configured to transmit a signal confirming reception of at least one message received by said at least one transceiver.

21. Device according to claim 17, wherein the portable communicating terminal comprises a location memory to store a location of said at least one smoke detector, and a storage manager to store, in the location memory of the portable communicating terminal, an identifier transmitted by said at least one transceiver.

22. Device according to claim 17, wherein said at least one smoke detector comprises a location memory, and a storage manager to store, in the location memory, an item of location information transmitted by the portable communicating terminal and received by said at least one transceiver, said at least one transceiver is configured to transmit an item of information representative of the item of location information with a signal representative of the presence of a fire.

23. Device according to claim 17, wherein said at least one smoke detector comprises an amplifier to amplify the signal transmitted by said at least one transceiver, said at least one transceiver is configured to receive a gain set point for the amplifier from the portable communicating terminal.

24. Device according to claim 17, wherein said at least one smoke detector comprises an amplifier to amplify the signal received by said at least one transceiver, said at least one transceiver is configured to receive a gain set point for the amplifier from the portable communicating terminal.

25. Device according to claim 17, wherein said at least one detector comprises an amplifier to amplify an alarm signal by said at least one transceiver, said at least one transceiver is configured to receive a gain set point for the amplifier from the portable communicating terminal.

26. Device according to claim 17, wherein the transmitter of the portable communicating terminal is configured to transmit to an alarm control unit each parameter value configured by the configurator for each fire detector.

27. Device according to claim 17, wherein said at least one smoke detector comprises at least one internal power supply, and at least one estimator to estimate a level of power available in said at least one internal power supply; and wherein said at least one transceiver is configured to transmit a signal representative of an available power level estimated by the estimator.

28. Device according to claim 17, wherein said at least one transceiver is configured to transmit an alarm signal to at least one recipient in response to the detection of the presence of a fire; and wherein the portable communicating terminal is configured to control operation of said at least one transceiver.

29. Device according to claim 17, wherein said at least one transceiver utilizes at least one of the following: a WiFi protocol or Bluetooth technology.

30. Portable communicating terminal for configuring a smoke detector comprising:
a sensor to measure a measurement value of a physical magnitude near the sensor to transmit a signal representative of the measurement value;
a fire detector to detect a presence of a fire based on processing of the signal transmitted by the sensor;
a short-range transceiver to wirelessly communicate a signal representative of the presence of a fire;
a receiver to receive the signal communicated by the transceiver;
a display screen to display a message representative of the signal received from the transceiver;
a configurator to configure at least one parameter value of processing performed by the fire detector; and
a transmitter to wirelessly transmit to the smoke detector a signal representative of each parameter value configured by the configurator.

31. Detector of a fire-detection system, comprising:
a sensor to measure a measurement value of a physical magnitude near the sensor to transmit a signal representative of the measurement value;
a fire detector to detect a presence of a fire based on processing of the signal transmitted by the sensor;
a short-range wireless transceiver to transmit a signal representative of the presence of a fire and to receive a signal representative of each parameter value configured by a configurator of a portable communicating terminal; and
wherein the detector utilizes at least one parameter value received by the short-range wireless transceiver to detecting the presence of a fire.

32. Method for configuring a fire detection system comprising at least one detector, comprising the steps of:
capturing a measurement value of a physical magnitude near a sensor of said at least one detector to transmit a signal representative of the measurement value by said at least one detector;
detecting a presence of a fire based on processing of the signal transmitted by the sensor by a fire detector of said at least one detector;
short-range wireless communicating a signal representative of the presence of a fire by a short-range wireless transceiver of said at least one detector;
receiving the signal communicated by said at least one detector by a portable communicating terminal;
displaying a message representative of the signal received from said at least one detector on a display screen by the portable communicating terminal;
configuring at least one parameter value for processing performed by said at least one detector to detect the presence of a fire by a configurator of the portable communicating terminal;
wirelessly transmitting a signal representative of each parameter value configured by the configurator by a transmitter of the portable communicating terminal; and
receiving the signal representative of each parameter value configured by the configurator of the portable communication terminal by the short-range wireless transceiver of said at least one detector.
